(19) United States
(12) Patent Application Publication
(10) Pub. No.: US 2018/0227373 A1
(43) Pub. Date: Aug. 9, 2018

(54) METHOD AND SYSTEM FOR AN ONLINE USER GENERATED GEO-NETWORK FOR SOCIAL INTERACTION, COMMERCIAL BIDDING AND TRANSACTION, AND INFORMATION EXCHANGE

(71) Applicant: Lisa Rowlett Leslie, San Francisco, CA (US)

(72) Inventor: Lisa Rowlett Leslie, San Francisco, CA (US)

(21) Appl. No.: 15/943,242

(22) Filed: Apr. 2, 2018

Related U.S. Application Data
(63) Continuation of application No. 14/619,049, filed on Feb. 10, 2015, now abandoned.

(51) Int. Cl. H04L 29/08

(52) U.S. Cl. CPC H04L 67/18; H04L 67/306

(57) ABSTRACT

A computer-implemented method and system for an online user generated geo-network. The computer-implemented method includes creating a user account by allowing a user to fill in a plurality of user details. Further, the computer implemented method includes displaying a digital world map to the user, wherein the digital world map comprises of a plurality of locations displayed as spots on the digital world map. The computer-implemented method also includes geo-tagging the user automatically on the digital world map by allowing the user to input a current location, thereby creating a geo-network. Furthermore, the computer-implemented method includes allowing the user to perform a plurality of location based activities through the user account.

### TECHNICAL FIELD

Embodiments of the disclosure relate generally to the field of social networking. Embodiments relate more particularly to provide a secure online location based categorization platform for connecting with the rest of the online world. Consequently, users are allowed to find people, products, information and content through the Internet.

### BACKGROUND

Today, communication is the most vital activity for exchanging information across space and time using various technical or natural means. With the expanding development of the Internet, a number of online platforms (for example, Facebook, Google and Twitter) facilitate online search, social networking, e-commerce, online travel, “following” an entity, instant messenger and group chat to people. Subsequently, the people are allowed to find information, products, content and socialize across a network that interconnects the people. However, the existing online platforms demands pre-existing knowledge of people in order to communicate that limits boundaries of communication.

Another existing method of communication involves a geo-network (geographical network) to allow people to connect through locations on a map. The locations are displayed on a map using various technologies such as Global Positioning System (GPS), Internet Protocol (IP) address or cellular triangulation. Further, geo-networks facilitate global connectivity through the Internet. However, the geo-network also demands pre-existing knowledge of people for communication.

In the light of the above discussion, there appears to be a need for a method and system for facilitating global communication without the necessity of pre-requisite knowledge of people.

### OBJECT OF INVENTION

The principal object of the embodiments herein is to provide a method and system to create an online user generated geo-network for global connectivity between all people on the Internet.

Another object of the embodiments herein is to provide a secure online location based categorization platform to allow user to fine people, products, information and content.

### SUMMARY

The above-mentioned needs are met by a computer-implemented method and a system for an online user generated geo-network without the pre-requisite knowledge of searching for particular people, information, products, contents and services.

An example of a computer-implemented method for an online user generated geo-network includes creating a user account by allowing a user to fill in a plurality of user details. Further, the computer implemented method includes displaying a digital world map to the user, wherein the digital world map comprises of a plurality of locations displayed as spots on the digital world map. The computer-implemented method also includes geo-tagging the user automatically on the digital world map by allowing the user to input a current location, thereby creating a geo-network. Furthermore, the computer-implemented method includes establishing real-time interaction between the user and one or more other online users. Moreover, the computer-implemented method includes allowing the user to perform a plurality of location based activities through the user account.

An example of a system for an online user generated geo-network includes a plurality of computing devices operated by individual users. The system includes a world map interface configured within the computing devices that displays a digital world map to the users. The digital world map comprises of a plurality of locations displayed as spots on the digital world map. Further, the system includes a network that interconnects the computing devices and facilitates the users to login through the Internet thereby creating corresponding user accounts. Furthermore, the system includes a geographical network engine operable to geo-tag the users automatically on the digital world map by allowing the user to select a current location, thereby creating a geo-network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, according to the embodiments as disclosed herein;

FIG. 2 is a schematic representation of a user interaction screen to login, according to the embodiments as disclosed herein;

FIG. 3 is a schematic representation of a typical user interaction screen, according to the embodiments as disclosed herein;

FIG. 4 is a schematic representation of a user interaction screen of an online registration page for geo-network users, according to the embodiments as disclosed herein;

FIG. 5 is a flow diagram illustrating a method for creating an online user generated geo-network, according to the embodiments as disclosed herein;

FIG. 6 is a flow diagram illustrating a method to map members of a geo-network, according to the embodiments as disclosed herein;

FIG. 7a, FIG. 7b and FIG. 7c are exemplary representations of a user interference for following an event, according to the embodiments as disclosed herein;

FIG. 8 is an exemplary display page associated to the geographic network engine, according to the embodiments as disclosed herein;

FIG. 9 is an exemplary display page associated to the geographic network engine according to the embodiments as disclosed herein;

FIG. 10 is an exemplary display page associated to the geographic network engine according to the embodiments as disclosed herein;

FIG. 11 is an exemplary social editor page associated to the geographic network engine, according to the embodiments as disclosed herein;

FIG. 12 is an exemplary display page illustrating geo-mapped information exchange in context to a physical location in the real world, according to the embodiments as disclosed herein;

FIG. 13 is a block diagram of a machine in the example form of a computer system within which instructions for causing the machine to perform any one or more of the methodologies discussed herein may be executed.

### DETAILED DESCRIPTION OF THE EMBODIMENTS

The above-mentioned needs are met by a method and system for active learning through visualizations and animations controlled by a user. The following detailed description is intended to provide example implementations to one of ordinary skill in the art, and is not intended to limit the invention to the explicit disclosure, as one of ordinary skill in the art will understand that variations can be substituted that are within the scope of the invention as described.

As used herein, a person (user) who sends a real-time message or a real-time communication request to one or more people is referred to as a “first member” or a “first user”. As also used herein, a person who receives the real-time message or a real-time communication request is herein referred to as a “second member” or a “second user”.

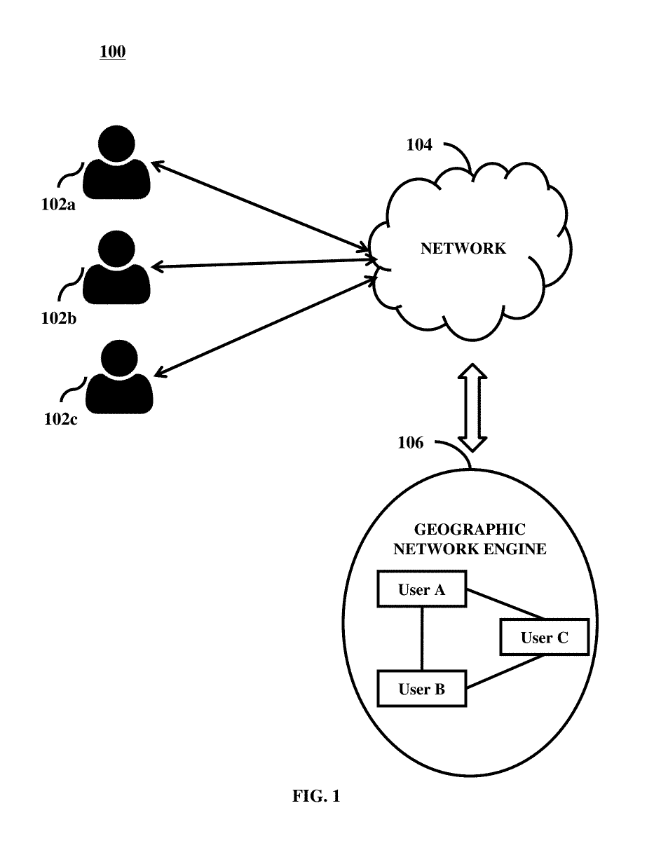

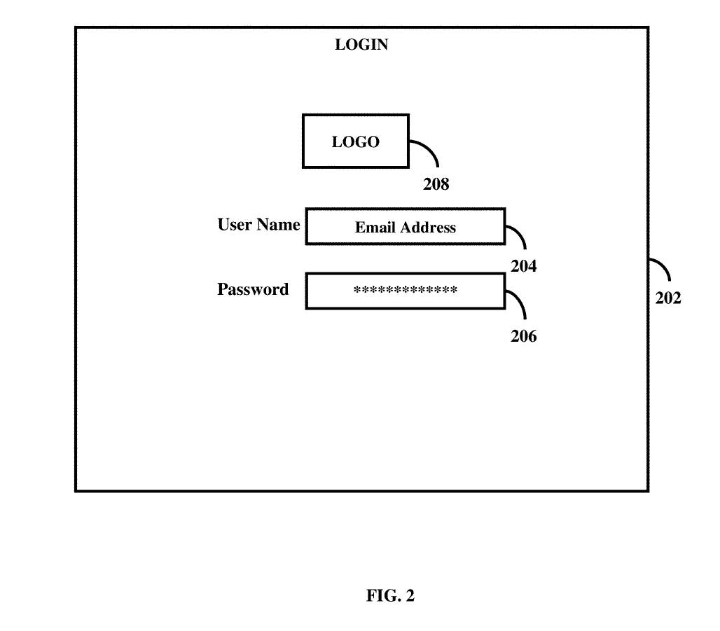

FIG. 1 is a block diagram of an environment, according to the embodiments as disclosed herein. The environment 100 includes a plurality of users, for example user 102a, user 102b and user 102c, a geo-network 104 and a geographic network engine 106.

The user 102a registers for location based activities through a user generated geo-network, typically by using a client machine which may be a personal computer. In some embodiments, the user may register for the location based activities by using a tablet device, a personal digital assistant (PDA), a laptop or some other portable computing device such as a cell phone and a smart phone. Moreover, the client machine is configured with a modern Web browser to access the Ibouge website.

An online registration process is required for the users to act as the first member and/or the second member. The online registration process is performed once. When a personal computer is used by the user 102a, the online registration process is initiated by the user 102a opening a Web browser to the Website registration page (typically Ibouge.com). The Web browser is connected to the Internet. When a portable computing device is used, the registration process may be initiated through a mini-browser or any other similar interface.

Upon successful registration, the user 102a becomes a member of the geo-network 104. Subsequently, the user is allowed to view and search for other online users within the geo-network (geo-graphical network). The user may choose to interact with the other online users or utilize any of the geographical networking services. Example of the geographical networking services include, but are not limited to, online searching, social networking, e-commerce, online travel, “following” an entity for receiving updates, micro blogging, instant messenger and group chat.

In a preferred embodiment, the geographic network engine 106 may be a geographic network website or one or more servers operating the geographic network engine 106. In some embodiments, the geographic network engine 106 may be any other device or an application capable of providing geographic networking services through the network 104.

The geographic network engine 106 facilitates creating a location based geo-network and a location based categorization platform to allow online users to explore the Internet and find people, products, information and content. Further, the user's pre-existing knowledge is not mandatory for the user to connect with other users, interact, find or use the geo-networking services.

The location based categorization platform organizes content, information, products and services based on where the product is being sold, what the content refers to (a location), what the information is about (location based information—such as online travel guides or micro-blogs where chat and blogging refers to the location on the map for which it is geo-tagged). In some embodiments, the location based categorization platform can be broadened to categorize any online service or online industry using a map based interface to organize information, product or service based on its relationship to a physical location.

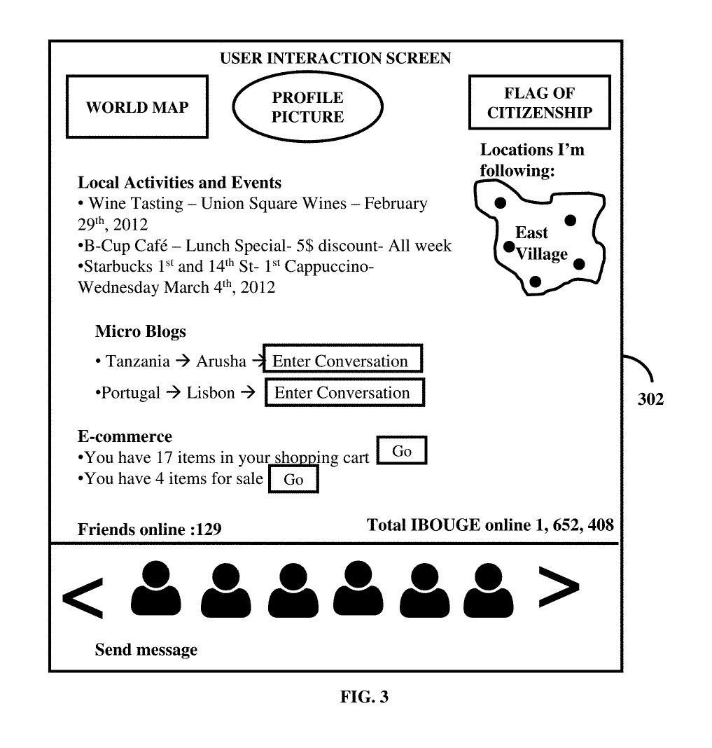

FIG. 2 is a schematic representation of a user interaction screen to login, according to the embodiments as disclosed herein. The user interaction screen 202 permits the user 102a to login subsequent to the registration process as mentioned in FIG. 1. The user is allowed to enter a user name 204 and a corresponding password 206. Further, the user 102a may upload a photo as a profile picture for visual representation of the user in the Logo 208.

FIG. 3 is a schematic representation of a typical user interaction screen, according to the embodiments as disclosed herein. The user interaction screen 302 is displayed for active members of the geo-network 104. Further, the user interaction screen 302 collectively displays various location based services that the user may utilize.

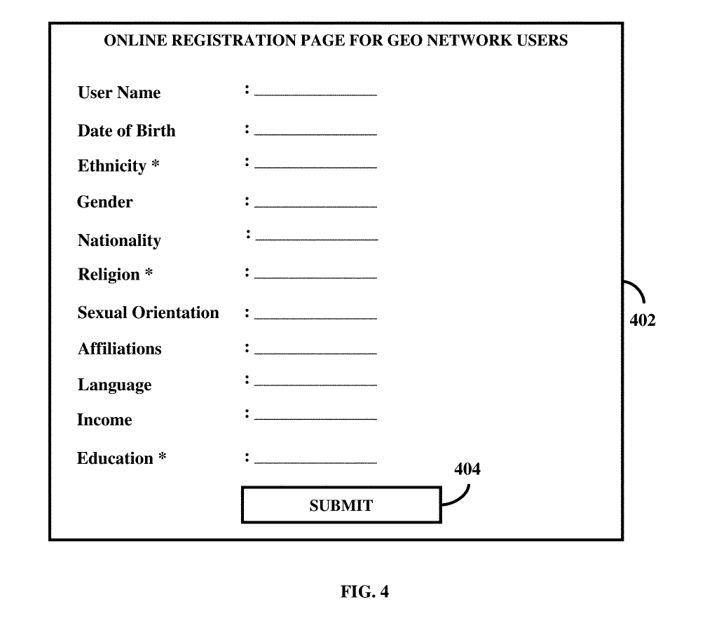

FIG. 4 is a schematic representation of a user interaction screen of an online registration page for geo-network users, according to the embodiments as disclosed herein. The registration page 402 allows users who wish to become members of the geo-network to register online (in real time). Further, the registration page 402 includes details such as user name, date of birth, ethnicity, gender, nationality, religion, sexual orientation, affiliations, language, income and education. The Submit 404 button completes and approves the registration process.

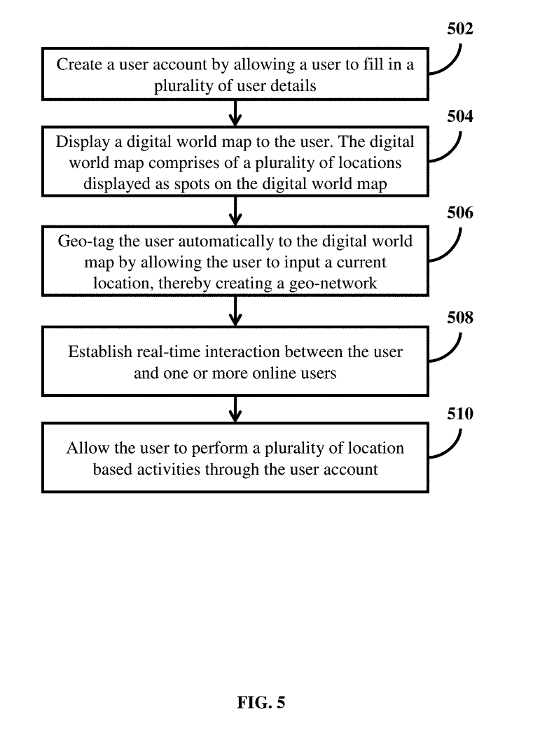

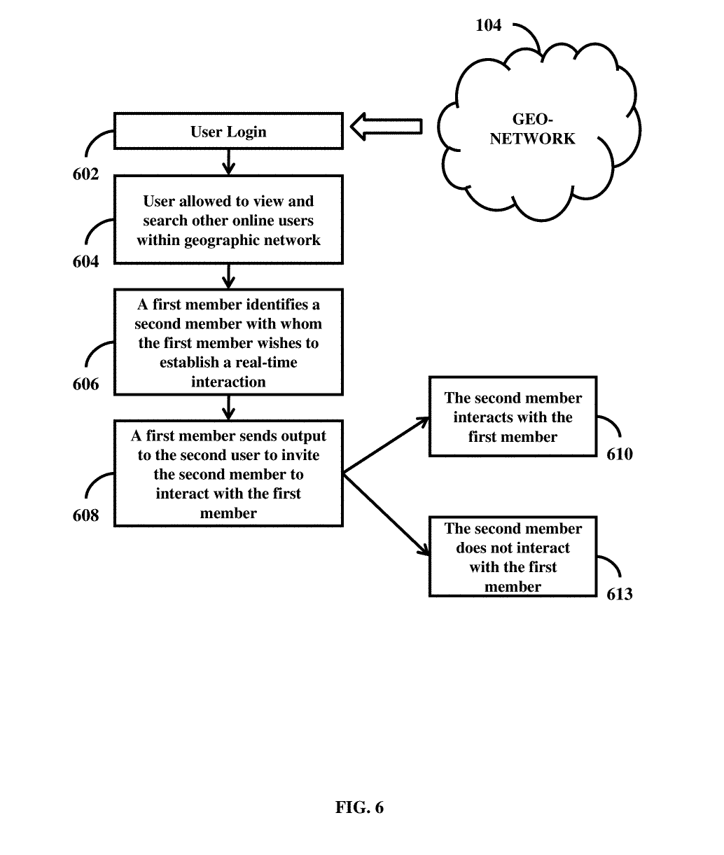

FIG. 5 is a flow diagram illustrating a method for creating an online user generated geo-network, according to the embodiments as disclosed herein. The flow diagram begins at step 502.

At step 502, a user account is created by allowing the user to open a Web browser to access a website registration page (Ibouge.com). The registration page displays a list of details for the user to fill in. Subsequently, the user is registered as a member of a geo-network. Typically, the geo-networking provides a secure online platform for connecting the user with the rest of the online digital world map users. Consequently, the users benefit exploring and discovering the Internet in a safe environment.

Further, the user account that is created provides the user to access location based activities. Basically, the location based activities have been re-designed (or re-invented) on Ibouge.com such as, e-commerce, getting updates about local activities and events, accessing knowledge on travel designations, performing an online search, donating to charities and communicating in groups or via instant messenger.

At step 504, a digital world map is displayed to the user. The digital world map comprises of a plurality of locations displayed as spots on the digital world map as they are related to a physical location in the real world. The spots may be different shapes, sizes and colors. Basically, the digital world map allows the user to connect and explore the rest of the online site through the map by zooming in and out of different countries, find people online, product and services and find content and information online (ibouge.com).

At step 506, the user is automatically geo-tagged on the digital world map at the point when the user selects a current physical location. The website provides a map based interface to allow the user to geo-tag themselves as a user of the geo-network. Consequently, the user is permitted to see other online users who are also tagged on the digital world map.

In some embodiments, the user may be tagged by Geographical Positioning System (GPS), Internet Protocol (IP) address or cellular triangulation for seamless usability. The geo-tagging enables global connectivity between all other online users of the geo-network to enable users to explore, search and find others based on location. Further, the connectivity eliminates the necessity of a pre-existing social relationship between the user and the other online users in order to search, find and connect with others.

As a result of the user voluntary geo-tagging on the digital world map, the geo-network is user generated. Subsequently, all network members are geo-mapped into a single virtual world map. The user generated geo-network (also referred to as “user generated location intelligence” or “user generated identification network”) is less technically savvy of automatically detecting a user's location with technology and displaying the user's location on a world map.

The user has the ability to “surf” the digital world map and also “zoom-in” and “zoom-out” to explore and connect with the other users. For example, the user may “surf” to locate other users in Australia. Further, the user wants to “zoom-in” Australia, to find other online users in Auckland.

Further, the location of the user may be stored to enable the user to login at another time under the profile settings. In some embodiments, the location is stored in a database or a server as IP addresses for the location.

At step 508, an interaction is established between the user and one or more online users of the geo-network. The other online users of the geo-network are represented as dots on the digital world map. The user (first member) can request another user (second member) to interact. The second user may or may not choose to interact with the first user.

At step 510, the user is allowed to perform a plurality of location based activities through the user account. Example of the location based activities include, but are not limited to the following:
1. Geo-location based “following”—follow a location for local activities and events —updates to newsfeed.
2. Geo-location based—micro blogging—chat contextual conversations talking about a specific place on the world map.
3. Location based e-commerce.
4. Location based social networking.
5. Location based online travel guides.

6. Location based instant messenger showing multiple separate instant message conversations on a single screen.
7. Location based group chat.
8. Location based search.
9. Location based global giving platform for NGO's, non profits and charities;

A further location based activity involves in digitalizing pre-existing travel book information on a map interface. The digitalizing includes creating, modifying and categorizing the travel book.

Consequently, Ibouge.com establishes the following:
1. A proprietary user interface to manage social, e-commerce, local activities and events as newsfeed.
2. A proprietary e-commerce bidding platform.
3. A proprietary travel interface with filters to access travel book information by country.
4. A proprietary design for multiple instant messenger and group chat.
5. A proprietary functionality and design to select an area on the digital world map and follow the area for updates in local neighborhood.

The flow diagram ends at step 510.

The method described in FIG. 5 is specifically beneficial to the following groups:
1. People interested in receiving local updates on events and activities in the neighborhood.
2. People who are interested in connecting with neighbors or unknown people in other countries.
3. People who desire to share and interact with large numbers of people typically outside social networks.
4. People interested in global connectivity.
5. People interested in global e-commerce platform.
6. People interested in accessing digital travel book information.
7. People interested in global giving and work for efficient charity goals.

Further, the method described in FIG. 5 provides complete openness on the Internet for communication to users of Ibouge website. The method also provides a location based market place for global e-commerce. Furthermore, the user generated geo-network provides a more efficient social networking locally and globally.

FIG. 6 is a flow diagram illustrating a method for socializing members of a geo-network, according to the embodiments as disclosed herein. The geo-network 104 is utilized to identify and associate other geo-network members in order to decide if a user 102a wishes to establish an interaction with another user 102b. The flow diagram begins at step 602.

At step 602, a user opens a Web browser to login through the Website registration page (typically Ibouge.com).

At step 604, a user is allowed to view and search other online users within the geo-network 104. The other online users are represented as dots on the digital world map. The dots indicate corresponding locations of the online users.

At step 606, a first member identifies a second member with whom the first member wishes to establish a real-time interaction.

At step 608, the first member sends an output to the second user to invite the second member to interact with the first member. At this moment, the second member decides whether or not to interact with the first member.

At step 610, the second member chooses to interact with the first member.

At step 612, the second member chooses not to interact with the first member. The flow diagram ends at step 612.

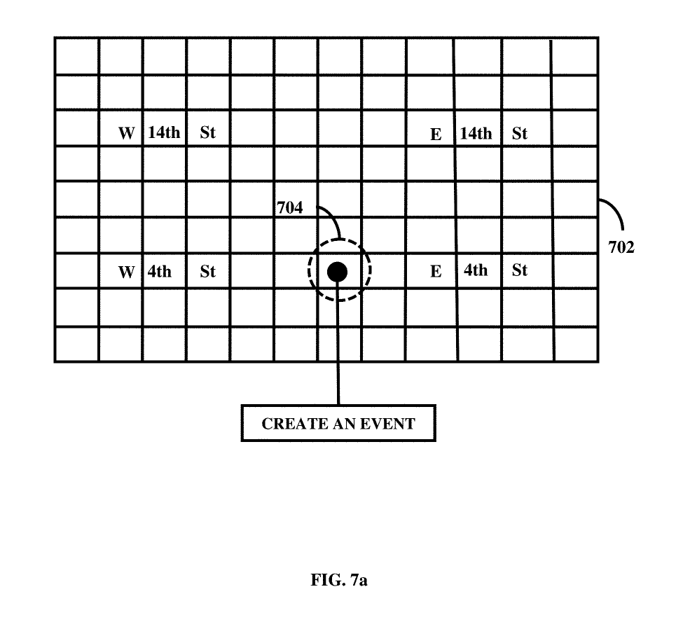

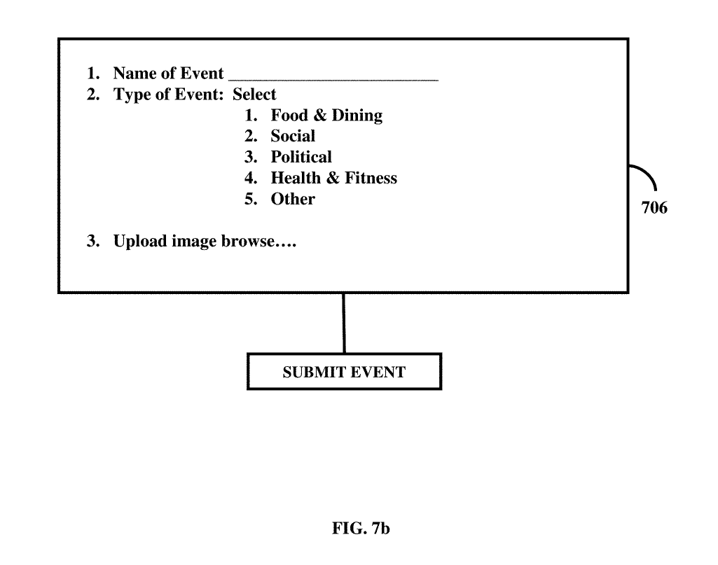

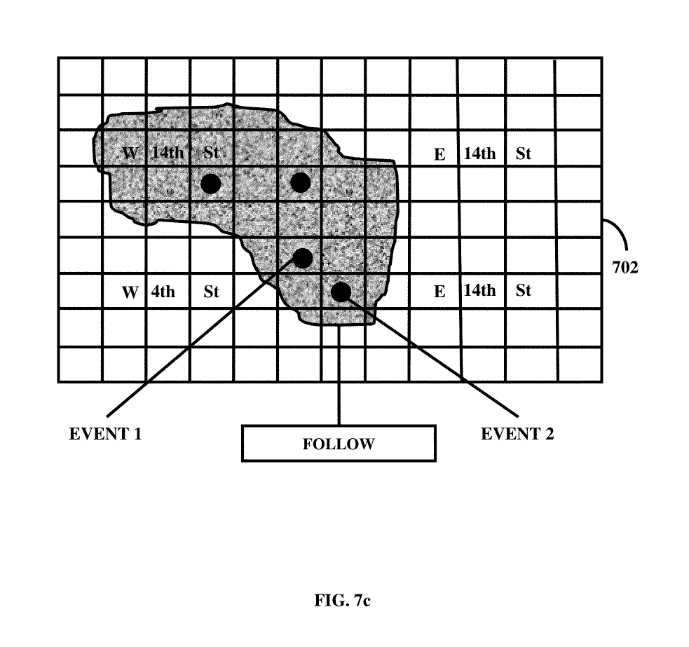

FIG. 7a, FIG. 7b and FIG. 7c are exemplary representations of user interference for following an event, according to the embodiments as disclosed herein.

FIG. 7a represents a world map 702. A user 102a initially zooms into a desired location of a world map 702. As a result, the world map 702 illustrates latitudes and longitudes of the zoomed location. The user 102a selects a point (location) 704 on the world map 702 and chooses to create an event for that particular point 704. Typically, an event is an occurrence of happening at a determinable time and place, for example a Wine Tasting event, a wedding ceremony and an exhibition.

FIG. 7b represents an exemplary representation of a display page for creating the event defined in FIG. 7a. The user 102a fills an event criterion 704 to be displayed to public or to those members who follow the event.

FIG. 7c represents the world map 702. The user 102a zooms into the world map 702 and selects an area to “follow”. Consequently, the user 102a receives the events that are posted within the selected area through a newsfeed.

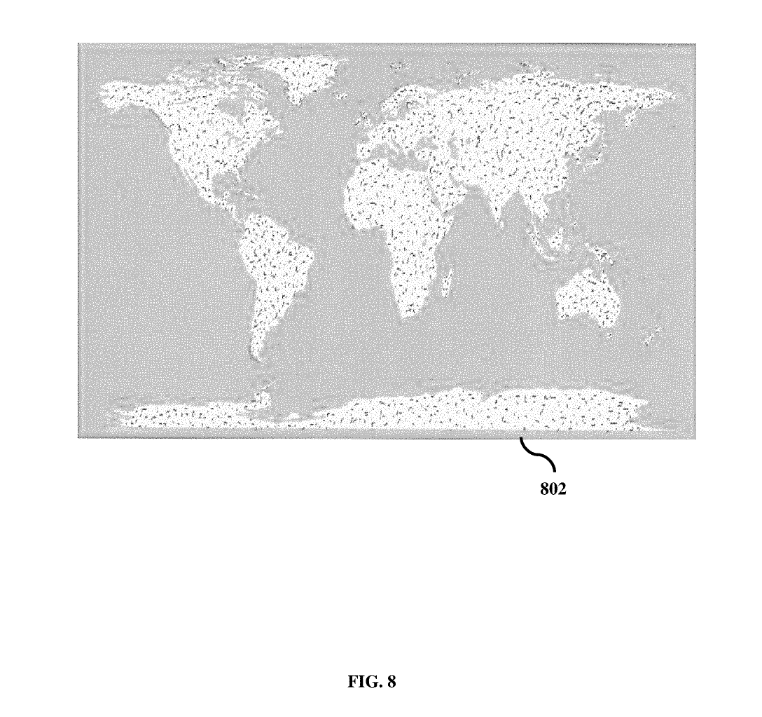

FIG. 8 is an exemplary display page associated to the geographic network engine, according to the embodiments as disclosed herein. The display page illustrates a world map 802 with a plurality of small black dots dispersed across the world map 802. Typically, each black dot represents a website of a plurality of geographic network members as they are geo-mapped and represented through corresponding physical locations in the real world.

Further, the display page represents a world geographic network that supports a single platform for all network members to communicate. For example, a member 102a may not necessarily have a previous social relationship or be socially mapped to a member 102b before deciding to interact.

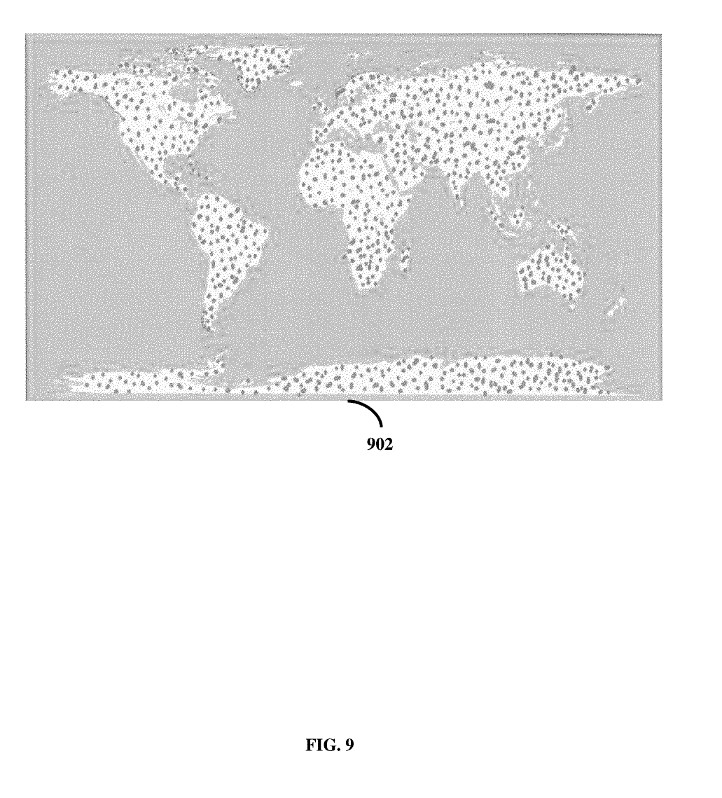

FIG. 9 is an exemplary display page associated to the geographic network engine according to the embodiments as disclosed herein. The display page illustrates a world map 902 with a plurality of medium sized green dots on the world map 902. Typically, each medium sized green dot represents a website of a plurality of products and services as they are geo-mapped through the location of the products and services in the real world. Further, the display page represents a world geographic network that may support a single platform for all members to buy or sell products and services with other network members through a secured online system of price bidding and payment (for example, Paypal) and delivery (for example, FedEx).

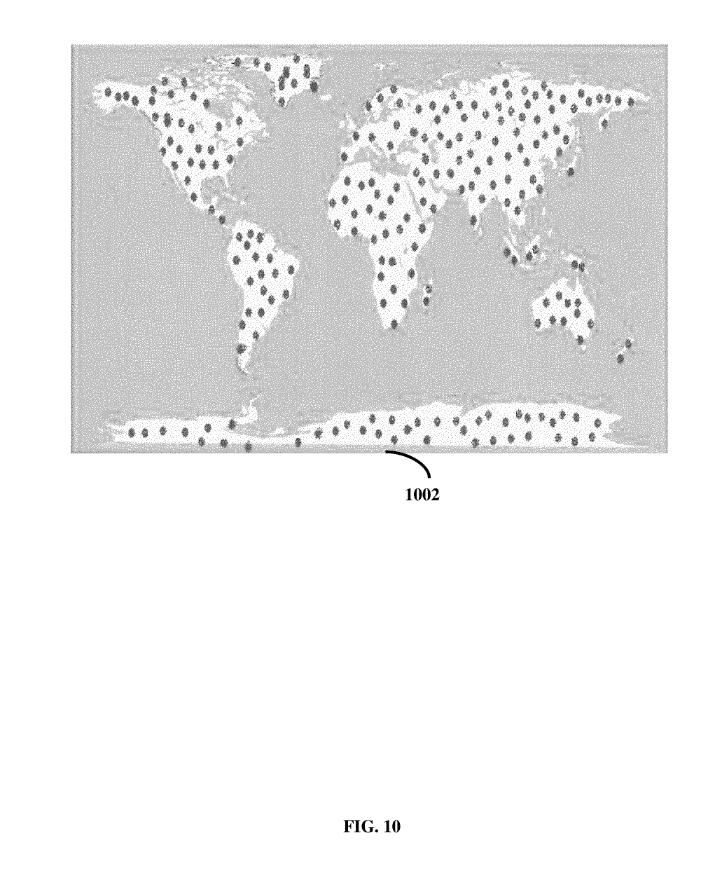

FIG. 10 is an exemplary display page associated to the geographic network engine according to the embodiments as disclosed herein. The display page illustrates a world map 1002 with a plurality of medium sized purple dots on the world map 1002. Typically, each medium sized purple dot represents a website of a plurality of informational uploads as they may be uploaded and geo-mapped by their context to a corresponding physical location in the “real” world. The world map 1002 also represents a world geographic network that may support a single platform for all members to upload and exchange information to the world map 1002 in context to its physical location in the “real” world.

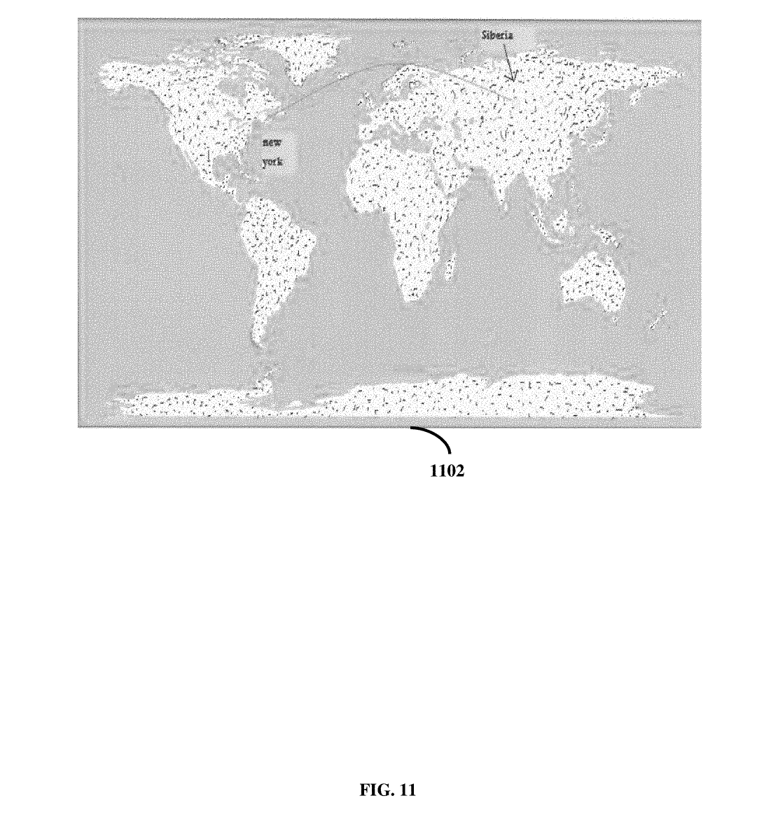

FIG. 11 is an exemplary social editor page associated to the geographic network engine, according to the embodiments as disclosed herein. The display page illustrates a world map 1102 with a plurality of small sized black dots on the world map 1102. Further, the world map 1102, illustrates a medium pink dot and a medium yellow dot that typically represents a member 102a and a member 102b respectively. The black dots represent a website of a plurality of geographic network members similar to FIG. 8.

The display page illustrates a process in which the member 102a may “surf” the world map 1102 while being geo-mapped to their current physical location. The member 102a explores the rest of the world map 1102 while being represented on the map as presented in “New York”. Subsequently, the member 102a “surfs” or “floats” the map to find the member 102b who is located in Siberia. As a result, the member 102a interacts socially, commercially or otherwise with a member 102b. An exemplary interaction between the member 102a and the member 102b is as follows:
Member 102a in New York: Hello, are you from Siberia?
Member 102b in Siberia: Yes, I live here.
Member 102a in New York: Oh, what do you do for a living?
Member 102b in Siberia: I make authentic bracelets.
Member 102a in New York: Do you have any for sale that I may purchase?
Member 102b in Siberia: Yes

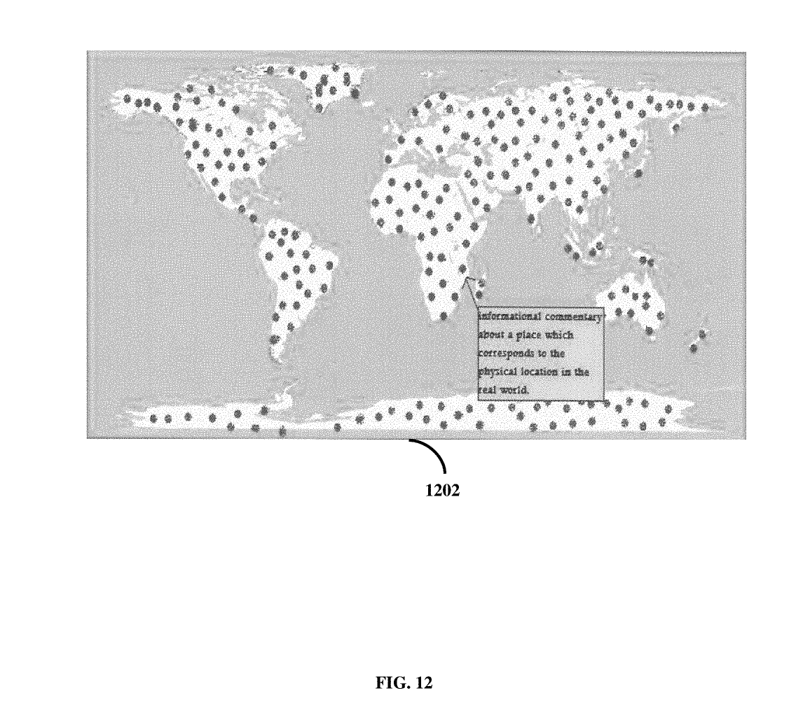

FIG. 12 is an exemplary display page illustrating geo-mapped information exchange in context to a physical location in the real world, according to the embodiments as disclosed herein. The display page illustrates a world map 1202 with a plurality of small sized purple dots similar to FIG. 9.

Basically, FIG. 12 illustrates a conversation between a member 102a and a member 102b of the geographic network. The conversation is typically an informational commentary about a place which corresponds to the physical location in the real world. The conversation is as follows:
Member 102a: “I just went to Tanzania and it was the best trip ever”.
Member 102b: “That's awesome! I'm planning a trip to go there next month. Have any recommendation of sites to see?”
Member 102a: “Definitely, go to Lake Victoria and Mt. Kilimanjaro”.
Member 102b: “Places you would advise not to go?”
Member 102a: “Beware of ‘Café Aruba’ in the capital—I got my wallet stolen there . . . ”

### Exemplary System Architecture

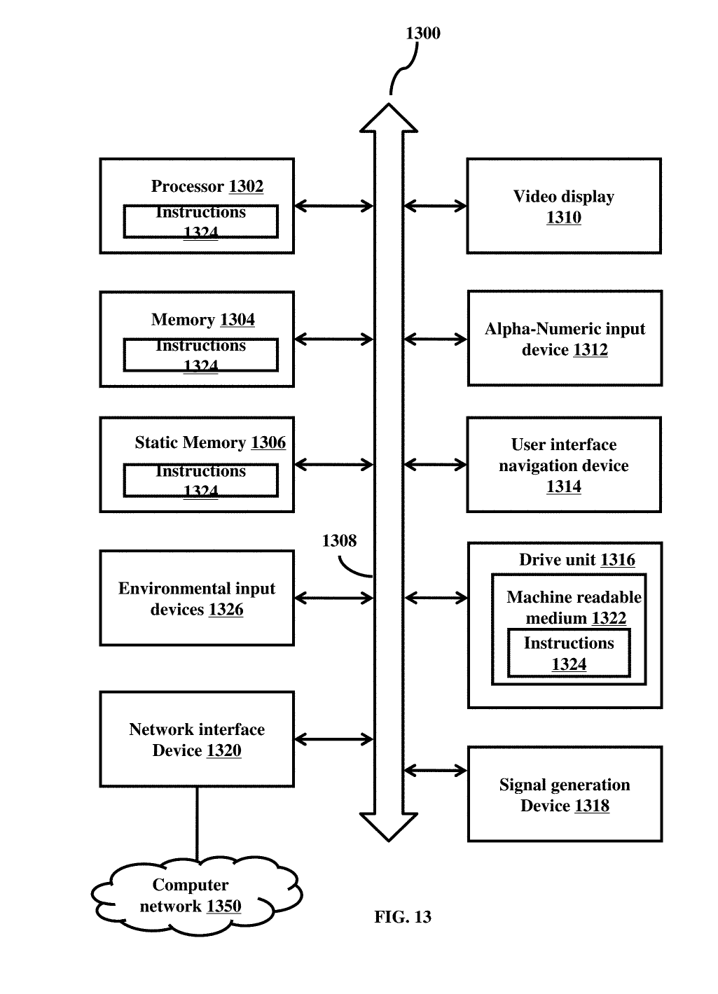

FIG. 13 is a block diagram of a machine in the example form of a computer system 1300 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a wearable computing device, a computing device connected to a display that can understand human gestures, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU), or both), a main memory 1304, and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device 1314 (e.g., a mouse), a disk drive unit 1316, a signal generation device 1318 (e.g., a speaker), and a network interface device 1320. The computer system 1300 may also include an environmental input device 1326 that may provide a number of inputs describing the environment in which the computer system 1300 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more instructions 1324 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 1324 may further be transmitted or received over a computer network 1350 using a transmission medium. The instructions 1324 may be transmitted using the network interface device 1320 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, Objective C, Swift, C++, C#, Pascal, Fortran, Perl, Matlab (from Math Works), SAS, SPSS, JavaScript, Python, Ruby, Ruby on Rails, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, ac, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Accordingly, the disclosure of the present invention is intended to be illustrative, but not limiting, of the scope of the invention, which is set forth in the following claims.

1. A computer-implemented method for an online user generated geo-network, the method comprising:
creating a user account by allowing a user to fill in a plurality of user details;
displaying a digital world map to the user, wherein the digital world map comprises of a plurality of locations displayed as spots on the digital world map;
geo-tagging the user automatically to the digital world map by allowing the user to input a current location, thereby creating a geo-network;
establishing real-time interaction between the user and one or more other online users; and
allowing the user to perform a plurality of location based activities through the user account.

2. The computer-implemented method of claim 1 wherein the user is allowed to find people, products, information and content based on the locations without pre-existing knowledge by the user.

3. The computer-implemented method of claim 1 wherein geo-tagging the users enables global connectivity with all other online users of the website.

4. The computer-implemented method of claim 1, wherein the location based activities are geo-location based “following”, geo-location based micro blogging, location based e-commerce, location based social networking, location based online travel guides, location based instant messenger, location based group chat, location based search and location based global giving platform for NGO's, non-profits and charities.

5. The computer-implemented method of claim 5 and further comprising:
viewing the location based activities as newsfeed on a user profile page.

6. The computer-implemented method of claim 1 and further comprising:
allowing the user to surf the digital world map and also zoom in and zoom out to explore a desired location.

7. The computer-implemented method of claim 1 and further comprising:
storing the location of the user subsequent to geo-tagging.

8. The computer-implemented method of claim 4 and further comprising:
digitalizing a pre-existing travel book information.

9. The computer-implemented method of claim 8 and further comprising:
using filters to organize the travel book information.

10. A computer program product stored on a non-transitory computer-readable medium that when executed by a processor, performs a method for an online user generated geo-network, comprising:
creating a user account by allowing a user to fill in a plurality of user details;
displaying a digital world map to the user, wherein the digital world map comprises of a plurality of locations displayed as spots on the digital world map;
geo-tagging the user automatically on the digital world map by allowing the user to input a current location, thereby creating a geo-network;
establishing real-time interaction between the user and one or more other online users; and
allowing the user to perform a plurality of location based activities through the user account.

11. The computer program product of claim 10 wherein the user is allowed to find people, products, information and content based on the locations without pre-existing knowledge by the user.

12. The computer program product of claim 10 wherein geo-tagging the users enables global connectivity with all other online users of the web site.

13. The computer program product of claim 10 wherein the location based activities are geo-location based “following”, geo-location based micro blogging, location based e-commerce, location based social networking, location based online travel guides, location based instant messenger, location based group chat, location based search and location based global giving platform for NGO's, non-profits and charities.

14. The computer program product of claim 13 and further comprising:
viewing the location based activities as newsfeed on a user profile page.

15. The computer program product of claim 10 and further comprising:
allowing the user to surf the digital world map and also zoom in and zoom out to explore a desired location.

16. The computer program product of claim 10 and further comprising:
storing the location of the user subsequent to geo-tagging.

17. The computer program product of claim 13 and further comprising:
digitalizing pre-existing travel book information.

18. The computer program product of claim 17 and further comprising:
using filters to organize the travel book information.

19. A system for online user generated geo-network, the system comprising:
a plurality of computing devices operated by individual users;
a world map interface configured within the computing devices, that displays a digital world map to the users, wherein the digital world map comprises of a plurality of locations displayed as spots on the digital world map;
a network that interconnects the computing devices and facilitates the users to login through the Internet thereby creating corresponding user accounts; and
a geographical network engine operable to geo-tag the users automatically on the digital world map by allowing the user to select a current location, thereby creating a geo-network.

20. The system of claim 19 and further comprising:
a computing module configured within the computing devices to allow the user to perform a plurality of location based activities through the user accounts.
